(19) United States
(12) Patent Application Publication
(10) Pub. No.: US 2025/0308801 A1
(43) Pub. Date: Oct. 2, 2025

(54) MULTILAYER CERAMIC ELECTRONIC COMPONENT

(71) Applicant: TAIYO YUDEN CO., LTD., Tokyo (JP)

(72) Inventor: Shohei KITAMURA, Tokyo (JP)

(21) Appl. No.: 19/078,835

(22) Filed: Mar. 13, 2025

(30) Foreign Application Priority Data
Mar. 29, 2024 (JP) 2024-056429

(51) Int. Cl. H01G 4/30; H01G 4/008; H01G 4/12

(52) U.S. Cl. CPC H01G 4/30; H01G 4/0085; H01G 4/1227

(57) ABSTRACT

To provide a multilayer ceramic electronic component having excellent internal electrode layer continuation percentage, a multilayer ceramic electronic component includes: a plurality of dielectric layers laminated along first axis; a plurality of internal electrode layers each positioned between dielectric layers adjacent to each other along first axis; and intermediate regions positioned between dielectric layers and internal electrode layers. Dielectric layers contain a compound represented by a general formula ABO_{3-α} (0≤α≤1) and having perovskite structure, and manganese. Internal electrode layers contain a base metal element as a main component, and copper. Intermediate regions contain manganese and copper. Average value of manganese content ratio by number of atoms in intermediate regions is greater than average value of manganese content ratio by number of atoms in first reference regions, which are regions, within dielectric layers, that are apart from second boundaries by 2 nm or greater and 5 nm or less.

### CROSS-REFERENCE TO RELATED APPLICATION

The present application claims priority under 35 U.S.C. § 119 to Japanese Patent Application No. 2024-056429, filed Mar. 29, 2024, the contents of which are incorporated herein by reference in their entireties.

### BACKGROUND OF THE INVENTION

### Field of the Invention

This disclosure relates to a multilayer ceramic electronic component.

### Description of the Related Art

Multilayer ceramic electronic components have a structure in which dielectric layers and internal electrode layers are laminated alternately. Examples of multilayer ceramic electronic components include multilayer ceramic capacitors (MLCCs).

Along with improvement in multifunctionality, performance, and the like of electronic devices, such as mobile phones, on which multilayer ceramic electronic components, such as multilayer ceramic capacitors, are mounted, reduction in size, increase in capacitance, and the like are required of multilayer ceramic electronic components. In order to meet such requirements, reduction in thickness of dielectric layers and internal electrode layers, and increase in number of laminated layers are required of multilayer ceramic electronic components. Therefore, regarding multilayer ceramic electronic components, studies have been conducted in order to enable the desired characteristics to be obtained when reduction in thickness of dielectric layers and internal electrode layers, and the like are put into practice.

For example, Japanese Patent Application Laid-Open Publication No. 2010-052964 discloses a dielectric ceramic containing a BaTiO₃-based material as a main component and containing Li as a sub component, and a multilayer ceramic capacitor including dielectric ceramic layers composed of the dielectric ceramic.

According to Japanese Patent Application Laid-Open Publication No. 2010-052964, when used as a constituent of dielectric ceramic layers of a multilayer ceramic capacitor, the disclosed dielectric ceramic can provide good lifetime characteristics to the multilayer ceramic capacitor even when the dielectric ceramic layers are reduced in thickness to less than 1 μm.

### SUMMARY OF THE INVENTION

Here, there is a melting point difference between the material of internal electrode layers and the material of dielectric layers, and the material of internal electrode layers tends to be compacted faster. Therefore, when a laminate in which dielectric green sheets, which become dielectric layers, and a metal paste, which becomes internal electrode layers, are arranged alternately so as to have a predetermined shape is fired, there is a risk that the internal electrode layer continuation percentage becomes poor, and that desired design specifications cannot be achieved. Moreover, when internal electrode layers and the like are reduced in thickness, there is a risk that this tendency becomes more outstanding.

To provide a multilayer ceramic electronic component having an excellent internal electrode layer continuation percentage.

A disclosed multilayer ceramic electronic component includes:
a plurality of dielectric layers laminated along a first axis;
a plurality of internal electrode layers each positioned between those of the dielectric layers that are adjacent to each other along the first axis; and
intermediate regions positioned between the dielectric layers and the internal electrode layers,
wherein the dielectric layers contain a compound represented by a general formula ABO_{3-α} (0≤x≤1) and having a perovskite structure, and manganese,
wherein the internal electrode layers contain a base metal element as a main component, and copper,
wherein the intermediate regions contain manganese and copper, and
wherein when a three-dimensional atom probe analysis is performed, to find first boundaries, which are boundaries between the internal electrode layers and the intermediate regions, to be at positions at which a content ratio of oxygen by number of atoms is 5 at %, and to find second boundaries, which are boundaries between the dielectric layers and the intermediate regions, to be at positions at which a content ratio of oxygen by number of atoms and a content ratio by number of atoms of the base metal element as the main component are equal to each other, an average value of a content ratio of manganese by number of atoms in the intermediate regions is greater than an average value of a content ratio of manganese by number of atoms in first reference regions, which are regions, within the dielectric layers, that are apart from the second boundaries by 2 nm or greater and 5 nm or less.

According to the present disclosure, it is possible to provide a multilayer ceramic electronic component having an excellent internal electrode layer continuation percentage.

### BRIEF DESCRIPTION OF THE DRAWINGS

FIG. 1 is a partially sectioned oblique view illustrating a multilayer ceramic capacitor according to an embodiment of the present disclosure;

FIG. 2 is a cross-sectional view illustrating a multilayer ceramic capacitor according to an embodiment of the present disclosure;

FIG. 3 is a cross-sectional view illustrating a multilayer ceramic capacitor according to an embodiment of the present disclosure;

FIG. 4 is a cross-sectional view illustrating the details of an element body according to an embodiment of the present disclosure;

FIG. 5 is a view explaining a method for identifying presence or absence of an intermediate region;

FIG. 6 is a flowchart of a method of producing a multilayer ceramic capacitor according to an embodiment of the present disclosure;

FIG. 7A is a view illustrating a method of producing a multilayer ceramic capacitor according to an embodiment of the present disclosure;

FIG. 7B is a view illustrating a method of producing a multilayer ceramic capacitor according to an embodiment of the present disclosure;

FIG. 8 is an example of a measurement result of a three-dimensional atom probe analysis; and

FIG. 9 is a view for explaining a method for evaluating an internal electrode layer continuation percentage.

### DETAILED DESCRIPTION OF THE DISCLOSURE

Embodiments of the present disclosure will be described in detail below, but the present disclosure is not limited to these embodiments. In the present specification and drawings, components having substantially the same functional configuration may be omitted from duplicate descriptions by assigning the same reference numerals. In the drawings, an X-axis, a Y-axis, and a Z-axis that are mutually orthogonal are shown where appropriate. The X-axis, Y-axis, and Z-axis define a fixed coordinate system that is fixed to a multilayer ceramic capacitor, which is an example of a multilayer ceramic electronic component. When the outer shape of a multilayer ceramic capacitor, which is an example of the multilayer ceramic electronic component, is approximately a rectangular parallelepiped, the X-axis, Y-axis, and Z-axis can correspond to the length, width, and height of approximately the rectangular parallelepiped. Hereinafter, using a multilayer ceramic capacitor, which is an example of the multilayer ceramic electronic component, the multilayer ceramic electronic component of this embodiment will be described.

### [Multilayer Ceramic Electronic Component]

### (1) Structure of Multilayer Ceramic Electronic Component

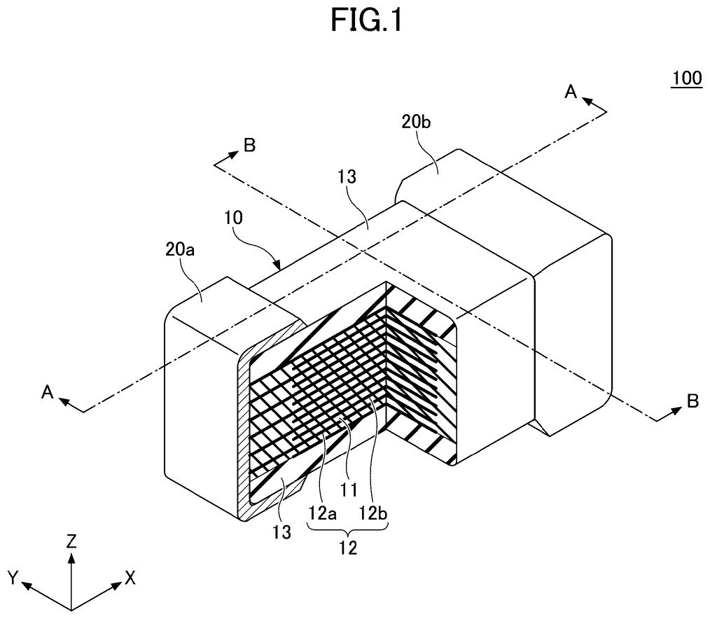

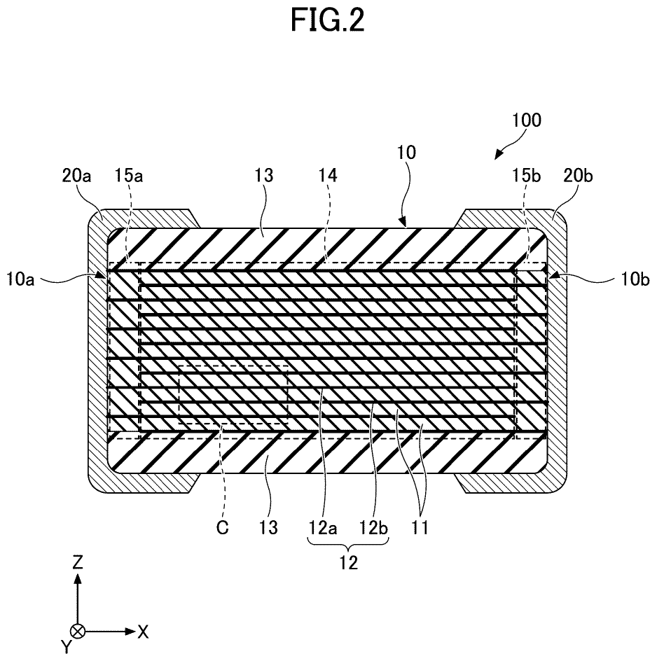

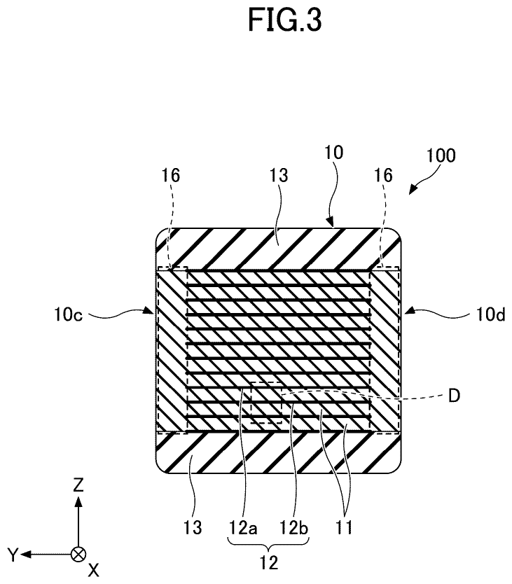

FIG. 1 is a partial sectioned oblique view illustrating a multilayer ceramic capacitor 100. FIGS. 2 and 3 are cross-sectional views illustrating the multilayer ceramic capacitor. FIG. 2 is a cross-sectional view taken along a line A-A in FIG. 1. FIG. 3 is a cross-sectional view taken along a line B-B in FIG. 1. As illustrated in FIGS. 1 to 3, the multilayer ceramic capacitor 100 includes an element body 10 having an approximately rectangular parallelepiped shape. Two surfaces of the element body 10, among surfaces thereof, that face each other are referred to as an upper surface and a lower surface, and four surfaces connecting the upper surface and the lower surface are referred to as side surfaces. Normally, a surface of the multilayer ceramic capacitor that is on the circuit board side is referred to as the lower surface, when mounting the capacitor on the circuit board. However, this is non-limiting. In the example of FIGS. 1 to 3, a first external electrode 20a and a second external electrode 20b are provided on a first side surface 10a and a second side surface 10b (see FIG. 2), which are two side surfaces of the element body 10 facing each other. The first external electrode 20a extends from the first side surface 10a to four adjacent surfaces. The second external electrode 20b extends from the second side surface 10b to four adjacent surfaces. However, the first external electrode 20a and the second external electrode 20b are spaced apart from each other. The external electrodes may be provided on anywhere other than the two facing side surfaces, as long as it is on a surface of the element body 10.

The lamination direction in which dielectric layers 11 and internal electrode layers 12 are laminated is along a first axis. In FIGS. 1 to 3, the first axis, which is in the lamination direction of the dielectric layers 11 and the internal electrode layers 12, is the Z-axis, and is in the direction in which the internal electrode layers face each other.

An axis which is perpendicular to the first axis, which is in the lamination direction, is a second axis. In FIGS. 1 to 3, the second axis perpendicular to the first axis, which is in the lamination direction, is the X-axis. The second axis is an axis that is along the length direction of the element body 10, and is along the direction in which the first side surface 10a and the second side surface 10b of the element body 10 face each other and the direction in which the first external electrode 20a and the second external electrode 20b face each other.

An axis which is perpendicular to the first axis, which is in the lamination direction, and is also perpendicular to the second axis is a third axis. The third axis is along the width of the internal electrode layers 12. In FIGS. 1 to 3, the third axis that is perpendicular to the first axis, which is in the lamination direction, and is also perpendicular to the second axis is the Y-axis, and is an axis that is along a direction in which a third side surface 10c and a fourth side surface 10d, which are two side surfaces other than the first side surface 10a and the second side surface 10b among the four side surfaces of the element body 10, face each other (see FIG. 3). The X-axis, the Y-axis, and the Z-axis are orthogonal to each other.

The lamination direction is not limited to the Z-direction, but can be any direction. Therefore, for example, the first axis, which is in the lamination direction, may be the X-axis in the X-direction or the Y-axis in the Y-direction.

In this specification, in order to describe general embodiments, a drawing illustrating one specific embodiment among the embodiments may be used. However, the contents described based on the coordinate system used in one embodiment are applicable to the general embodiments by reading the coordinate system of the one embodiment as a general coordinate system in which the lamination direction is along the first axis. For example, those that are used in FIGS. 1 to 3 relating to one specific embodiment in which the lamination direction coincides with the Z-direction and that are described as the X-axis, the Y-axis, and the Z-axis are applicable to the general embodiments by reading them as the second axis, the third axis, and the first axis.

The element body 10 has a structure in which the dielectric layers 11 containing a ceramic material functioning as a dielectric material and the internal electrode layers 12 are laminated alternately. The internal electrode layers 12 include a plurality of first internal electrode layers 12a and a plurality of second internal electrode layers 12b. The first internal electrode layers 12a and the second internal electrode layers 12b are laminated alternately. The edges of the first internal electrode layers 12a are drawn out to the surface of the element body 10 on which the first external electrode 20a is provided, which is the first side surface 10a in the example of FIGS. 1 to 3. The edges of the second internal electrode layers 12b are drawn out to the surface of the element body 10 on which the second external electrode 20b is provided, which is the second side surface 10b in the example of FIGS. 1 to 3. Thus, the first internal electrode layers 12a and the second internal electrode layers 12b are in alternate electrical conduction to the first external electrode 20a and the second external electrode 20b. Therefore, the multilayer ceramic capacitor 100 has a configuration in which capacitor units are laminated. In the laminate of the dielectric layers 11 and the internal electrode layers 12, internal electrode layers 12 are positioned on the outermost layers in the lamination direction, and the outer surfaces of the laminate in the lamination direction, which are the upper surface and the lower surface in the example of FIGS. 1 to 3, are covered by a cover layer 13. The cover layer 13 is mainly composed of a ceramic material. For example, the cover layer 13 may have a composition that is the same as or different from the dielectric layers 11. The configuration shown in FIGS. 1 to 3 is non-limiting except that the first internal electrode layers 12a and the second internal electrode layers 12b are exposed to different regions among the surfaces of the laminate and are in electrical conduction to different external electrodes. The different regions among the surfaces of the laminate may be surface regions included in facing surfaces of the laminate, respectively, may be surface regions included in adjacent surfaces of the laminate, respectively, or may be different surface regions included in the same surface of the laminate. As long as the different external electrodes are spaced apart from each other, the external electrodes may extend from the surfaces of the laminate, which include the surface regions to which the first internal electrode layers 12a and the second internal electrode layers 12b are exposed, to any other surface.

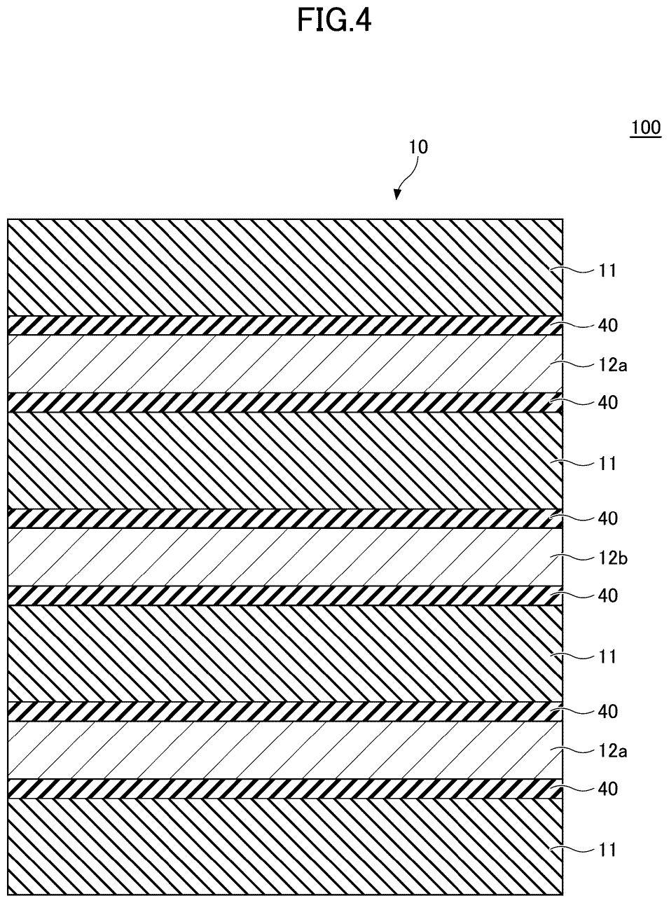

Details being described later, the element body 10 includes a plurality of intermediate regions 40 (see FIG. 4) between the dielectric layers 11 and the internal electrode layers 12. In FIGS. 1 to 3, description of the intermediate regions 40 is omitted.

The size of the multilayer ceramic capacitor 100 is not particularly limited. For example, the length may be 0.25 mm, the width may be 0.125 mm, and the height 0.125 mm. The length may be 0.4 mm, the width may be 0.2 mm, and the height 0.2 mm. The length may be 0.6 mm, the width may be 0.3 mm, and the height may be 0.3 mm. The length may be 1.0 mm, the width may be 0.5 mm, and the height may be 0.5 mm. The length may be 3.2 mm, the width may be 1.6 mm, and the height may be 1.6 mm. The length may be 4.5 mm, the width may be 3.2 mm, and the height may be 2.5 mm. The sizes of the multilayer ceramic capacitor 100 listed above are only examples, and the multilayer ceramic capacitor is not limited to the above sizes. The sizes of the multilayer ceramic capacitor 100 may be in the relationship of, for example, length>width≥height, width>length≥height, height>length≥width, or height>width≥length. For example, the length represents the size in the X-axis direction, the width represents the size in the Y-axis direction, and the height represents the size in the Z-axis direction.

As described above, the multilayer ceramic capacitor 100 of this embodiment includes the plurality of dielectric layers 11 laminated along the Z-axis, which is the first axis, and the plurality of internal electrode layers 12 each positioned between those of the dielectric layers 11 that are adjacent to each other along the first axis. Furthermore, the multilayer ceramic capacitor 100 of this embodiment includes the intermediate regions 40 positioned between the dielectric layers 11 and the internal electrode layers 12. The dielectric layers 11, the internal electrode layers 12, and the intermediate regions 40 will be described below.

### (2) Dielectric Layers

The dielectric layers 11 contain a compound represented by the general formula ABO_{3-α} (0≤x≤1) and having a perovskite structure, and manganese.

### (2-1) Components Contained in Dielectric Layers

### (Compound Having Perovskite Structure)

When having a stoichiometric composition, a compound having a perovskite structure is represented by a general formula ABO₃, with α, which represents the amount of deviation from the stoichiometric composition, being 0. The compound having a perovskite structure represented by the above general formula may have α that is greater than 0 and 1 or less. In other words, the compound having a perovskite structure represented by the above general formula may have oxygen deficiency with respect to the stoichiometric composition.

As the compound having a perovskite structure, one or more types selected from barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) forming a perovskite structure, and the like can be used.

Examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, barium calcium zirconate titanate, and the like. The compound having a perovskite structure may contain oxygen deficiency regardless of whatever material it is.

It is preferable that the dielectric layers 11 contain barium titanate as the compound having a perovskite structure because barium titanate has particularly excellent dielectric properties. The dielectric layers 11 may contain barium titanate as a main component, or may be composed only of barium titanate. Barium titanate has excellent dielectric properties such as an extremely high dielectric constant and a small dielectric loss. Therefore, when the dielectric layers 11 contain barium titanate as the compound having a perovskite structure, the capacitance of the multilayer ceramic capacitor 100 can be increased. As used herein, the phrase “containing a component as a main component” means that the component is contained the most among the components contained, in terms of the ratio by number of moles.

The dielectric layers 11 may contain the compound having a perovskite structure as a main component. The dielectric layer 11 may contain, for example, the compound having a perovskite structure by 50 mol % or greater, or 90 mol % or greater.

### (Manganese)

The dielectric layers 11 may further contain manganese. Manganese may be contained in the state of a simple substance, or may form a compound with any other element or the like.

When the dielectric layers 11 contain manganese, the sintering temperature of the dielectric layers 11 can be lowered. Therefore, the sintering temperature of the laminate of dielectric green sheets, which become the dielectric layers 11, and a metal paste, which becomes the internal electrode layers 12, can be lowered, and the continuation percentage at which the internal electrode layers 12 are continuous can be increased.

The ratio of manganese contained in the dielectric layers 11 is not particularly limited, and manganese can be added and contained to the extent that intermediate regions described later are formed.

### (Additives)

The dielectric layers 11 may contain additives as optional components.

Additives that can be contained in the dielectric layers 11 are not particularly limited, and examples include: oxides containing one or more elements selected from zirconium (Zr), magnesium (Mg), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) and ytterbium (Yb)); oxides containing one or more elements selected from cobalt (Co), nickel (Ni), lithium (Li), boron (B), sodium (Na), potassium (K), and silicon (Si); glass containing cobalt, nickel, lithium, boron, sodium, potassium, and silicon; and the like.

### (2-2) Thickness of Dielectric Layers

The thickness of the dielectric layers 11 is not particularly limited, yet is, for example, preferably 1.0 μm or less, and more preferably 0.8 μm or less, in order to increase the capacitance by increasing the number of laminated layers while reducing the size of the multilayer ceramic capacitor 100.

The lower limit of the thickness of the dielectric layers 11 is not particularly limited. From the viewpoint of improving productivity and yield, the minimum value may be 2 to 4 times the average diameter of dielectric material particles used. For example, when the average diameter of dielectric material particles used is 0.1 μm, the lower limit of the thickness of the dielectric layers 11 can be from 0.2 μm or greater to 0.4 μm or greater.

The particle diameter of the dielectric material particles can be the Heywood diameter (the diameter of a circle having an area equal to the area of a dielectric material particle evaluated) in a cross-section in which the dielectric material particle is observed. The average diameter, which is the average value of the particle diameters of the dielectric material particles, can be the arithmetic mean value of the particle diameters of 50 or more and 200 or less arbitrarily selected dielectric material particles.

In evaluating the thickness of the dielectric layers 11, it is evaluated in a cross-section including the first axis that is equal to the lamination direction. For example, it is preferable to evaluate the thickness in a cross-section further including the second axis that is set to be perpendicular to the lamination direction or in a cross-section further including the third axis that is set to be perpendicular to the lamination direction and also perpendicular to the second axis, for ease of polishing and measurement. The multilayer ceramic capacitor 100 is polished in the third-axis direction for the former, and in the second-axis direction for the latter. Five layers are selected from the center part, and as well as each of the upper end part and the lower end part of the exposed dielectric layers 11 in the first-axis direction. When the number of the dielectric layers 11 is even, six layers are selected from the center part. The thickness of each selected dielectric layer is measured at three locations, namely, the center part, the left end part, and the right end part, and the average value of the measured thickness values is used as the thickness of each dielectric layer 11. Then, the average value of the thickness values of all the selected and evaluated dielectric layers 11 can be used as the thickness of the dielectric layers 11 of the multilayer ceramic capacitor 100.

In the example shown in FIGS. 1 and 2, since the first axis, which is the lamination direction, is in the Z-axis direction, the multilayer ceramic capacitor 100 is polished along the Y-axis, which is the third axis, and an XZ surface in which the dielectric layers 11 and the internal electrode layers 12 are laminated is exposed.

In this case, from the exposed XZ surface, five dielectric layers 11 located in the center on the Z-axis, which is the first axis, are selected, and five dielectric layers 11 located at each of the upper end and the lower end on the Z-axis, which is the first axis, are selected. When the number of the dielectric layers 11 is even, six layers may be selected from the center part. In this case, the dielectric layers 11 to be selected are selected from within a capacitive part 14.

Then, the thickness of each selected dielectric layer 11 is measured along the X-axis, which is the second axis, at three locations that are apart from an end by ¼, ½, and ¾ the length of the dielectric layer 11 along the X-axis, and the average value is used as the thickness of the dielectric layer 11. By the same procedure, the thickness of all the selected dielectric layers 11 is measured, and the average value can be used as the thickness of the dielectric layers 11 of the multilayer ceramic capacitor 100 evaluated.

The thickness of the dielectric layers 11 and the thickness of the internal electrode layers 12, which will be described later, are measured in an image of an observed cross-section or the like of the multilayer ceramic capacitor 100. Since the intermediate regions 40 are not clearly visible in appearance, when measuring the thickness of the dielectric layers 11 and the thickness of the internal electrode layers 12, the measurement is performed based on the boundary between the dielectric layers 11 and the internal electrode layers 12, which can be visually confirmed. Therefore, the intermediate regions 40 are counted in the thickness of the dielectric layers 11, and in the thickness of the internal electrode layers 12, which will be described later.

### (3) Internal Electrode Layers

### (3-1) Components Contained in Internal Electrode Layers

As illustrated in FIG. 2, a region where the first internal electrode layers 12a connected to the first external electrode 20a and the second internal electrode layers 12b connected to the second external electrode 20b face each other is a region where an electric capacitance is generated in the multilayer ceramic capacitor 100. Therefore, the region where an electric capacitance is generated is referred to as the capacitive part 14. That is, the capacitive part 14 is a region where internal electrode layers connected to different external electrodes and adjacent to each other across the dielectric layers 11 face each other.

A region where the first internal electrode layers 12a connected to the first external electrode 20a face each other in the lamination direction via no second internal electrode layers 12b connected to the second external electrode 20b is referred to as a first end margin 15a. A region where the second internal electrode layers 12b connected to the second external electrode 20b face each other in the lamination direction via no first internal electrode layers 12a connected to the first external electrode 20a is referred to as a second end margin 15b. Each end margin is a region where the internal electrode layers connected to the same external electrode face each other in the lamination direction via no internal electrode layers connected to a different external electrode. The first end margin 15a and the second end margin 15b are regions where internal electrode layers 12 which are at the same electrical potential face each other and no substantial electric capacitance is generated.

Side margins 16 are regions provided on the outer sides of the capacitive part 14 in the direction along the third axis perpendicular to the lamination direction and also perpendicular to the second axis, which is the Y axis in the example of FIG. 3. That is, the side margins 16 are outer regions adjacent to the capacitive part 14 when viewed in the lamination direction, and are outer regions that are adjacent to the capacitive part 14 on the sides to which the internal electrode layers 12 are not drawn out. The side margins 16 are also regions in which no electric capacitance is generated.

According to the studies of the inventor of the present invention, it is possible to increase the continuation percentage of the internal electrode layers 12 by manganese being contained in the dielectric layer 11, and this effect becomes especially high with an increase in the manganese content in the dielectric layers 11. However, manganese being contained in the dielectric layer 11 alone is not sufficient for the effect of increasing the continuation percentage of the internal electrode layers 12, considering the characteristics required of multilayer ceramic capacitors in recent years. Therefore, the inventor of the present invention carried out further studies, and succeeded in confirming that copper being contained in the internal electrode layers 12 resulted in formation of intermediate regions containing both manganese derived from the dielectric layers 11 and copper derived from the internal electrode layers 12 between the internal electrode layers 12 and the dielectric layers 11. In the intermediate regions, manganese derived from the dielectric layers 11 and copper derived from the internal electrode layers 12 may have been thickened, i.e., their concentration or ratio by number of atoms may have become higher than those in the dielectric layers 11 and the internal electrode layers 12. Therefore, the intermediate regions 40 may include both a thickened part of manganese derived from the dielectric layers 11 and a thickened part of copper derived from the internal electrode layers 12.

According to the studies of the inventor of the present invention, the continuation percentage of the internal electrode layers 12 can be particularly increased by the multilayer ceramic capacitor including such intermediate regions.

Therefore, the internal electrode layers 12 can contain a base metal as a main component and copper. The proportion of copper contained in the internal electrode layers 12 is not particularly limited, and copper can be added and contained to the extent that the intermediate regions described above are formed. Details of the intermediate regions will be described later.

In addition to copper, the internal electrode layers 12 may contain components used in internal electrode layers of multilayer ceramic capacitors. In particular, the internal electrode layers 12 may contain base metals such as nickel (Ni), tin (Sn), tungsten (W), and the like, or an alloy containing one or more types selected from the group of these base metals as the main component, i.e., the most in terms of ratio by number of moles.

It is preferable that the internal electrode layers 12 contain nickel, and the internal electrode layers may contain nickel as a main component, because nickel has excellent electrical characteristics and can reduce costs.

The main component of the first internal electrode layers 12a and the main component of the second internal electrode layers 12b may be the same or different. As an example, the main component of both the first internal electrode layers 12a and the second internal electrode layers 12b may be nickel.

### (3-2) Continuation Percentage of Internal Electrode Layers

The continuation percentage of the internal electrode layers 12 is not particularly limited, yet is preferably high from the viewpoint of achieving the designed capacitance of the multilayer ceramic capacitor 100, and is preferably 75% or greater, and more preferably 80% or greater. The continuation percentage of the internal electrode layers 12 may be 100% or less.

The method for evaluating the continuation percentage of the internal electrode layers 12 will be described in Examples. Therefore, description thereof is omitted here.

### (3-3) Thickness of Internal Electrode Layers

The thickness of the internal electrode layers 12 is not particularly limited, yet is, for example, preferably 0.8 μm or less, and more preferably 0.6 μm or less, from the viewpoint of increasing the capacitance by increasing the number of laminated layers while reducing the size of the multilayer ceramic capacitor 100.

The lower limit of the thickness of the internal electrode layers 12 is not particularly limited. Yet, in a case of forming the internal electrode layers 12 by printing a metal conductive paste by a printing method such as screen printing, gravure printing, or the like, the lower limit of the thickness thereof can be 0.4 μm or greater, from the viewpoint of improving productivity and yield. For example, in a case of forming the internal electrode layers 12 by a thin film process such as sputtering, vapor deposition, or the like, the lower limit of the thickness thereof can be equal to or greater than 0.1 μm, which is less than in the case of the printing method.

In evaluating the thickness of the internal electrode layers 12, it is evaluated in a cross-section including the first axis that is equal to the lamination direction, as in the case of the evaluation of the thickness of the dielectric layers 11. For example, it is preferable to evaluate the thickness in a cross-section further including the second axis that is set to be perpendicular to the lamination direction, or in a cross-section further including the third axis that is set to be perpendicular to the lamination direction and also perpendicular to the second axis, from the viewpoint of ease of polishing and measurement.

The multilayer ceramic capacitor 100 is polished so that the above-described cross-section is visible, and five layers are selected from each of the center part, the upper end part, and the lower end part of the exposed internal electrode layers 12 in the first-axis direction. When the number of the internal electrode layers 12 is even, six layers are selected from the center part. The thickness of each selected internal electrode layer 12 is measured at a total of three locations, namely, the center part, the left end part, and the right end part, and the average value of the measured thickness values is used as the thickness of each internal electrode layer 12. Furthermore, the average value of the thickness values of all the selected and evaluated internal electrode layers 12 can be used as the thickness of the internal electrode layers 12 of the multilayer ceramic capacitor 100.

In the example shown in FIGS. 1 and 2, since the first axis, which is in the lamination direction, is the Z-axis direction, the multilayer ceramic capacitor 100 is polished along the Y-axis, and an XZ surface in which the dielectric layers 11 and the internal electrode layers 12 are laminated are exposed. In this case, from the XZ surface exposed by polishing, five internal electrode layers 12 located in the center on the Z-axis, which is the first axis, and five internal electrode layers 12 located at each of the upper end and the lower end on the Z-axis, which is the first axis, are selected. When the number of the internal electrode layers 12 is even, six layers may be selected from the center part. In this case, the internal electrode layers 12 to be selected are selected from within the capacitive part 14.

Then, the thickness of each selected internal electrode layer 12 is measured along the X-axis, which is the second axis, at three locations that are apart from an end by ¼, ½, and ¾ the length of the internal electrode layer 12 along the X-axis, and the average value is used as the thickness of the internal electrode layer 12. By the same procedure, the thickness of all the selected internal electrode layers 12 is measured, and the average value of the thickness values of all the selected and evaluated internal electrode layers 12 can be used as the thickness of the internal electrode layers 12 of the evaluated multilayer ceramic capacitor 100.

### (4) Intermediate Regions

FIG. 4 shows a partially enlarged view of the dielectric layers 11 and the internal electrode layers 12 of the element body 10. FIG. 4 is, for example, an enlarged view of a region D in FIG. 3.

The multilayer ceramic capacitor 100 includes the intermediate regions 40 containing manganese and copper and positioned between the dielectric layers 11 and the internal electrode layers 12. Since FIG. 4 is a schematic view, each of the intermediate regions 40 is illustrated as a continuous layer having a constant thickness. However, this configuration is non-limiting. For example, the intermediate regions 40 may be discontinuous, and may have different thicknesses depending on the location.

The presence or absence of the intermediate regions 40 can be confirmed by element mapping by Energy Dispersive X-ray Spectroscopy (EDX) using a Transmission Electron Microscope (TEM) or a Scanning Transmission Electron Microscope (STEM). The evaluation is performed in a cross-section including the first axis that is equal to the lamination direction. For example, it is preferable to perform the evaluation in a cross-section further including the second axis that is set to be perpendicular to the lamination direction, or in a cross-section further including the third axis that is set to be perpendicular to the lamination direction and also perpendicular to the second axis, from the viewpoint of ease of polishing and measurement. In the example shown in FIGS. 1 and 2, since the first axis, which is in the lamination direction, is in the Z-axis direction, the multilayer ceramic capacitor 100 is polished along the Y-axis that is the third axis, and an XZ surface in which the dielectric layers 11 and the internal electrode layers 12 are laminated is exposed. Then, by performing a TEM/STEM-EDX analysis of a thin piece sample, which is obtained from this sample to have a thickness of approximately 0.1 μm, it is possible to confirm the presence or absence of the intermediate regions 40.

For example, it is possible to determine the presence or absence of formation of the intermediate regions 40, by observing a part, in the obtained elemental mapping result, in which the dielectric layers 11 and internal electrode layers 12 are laminated.

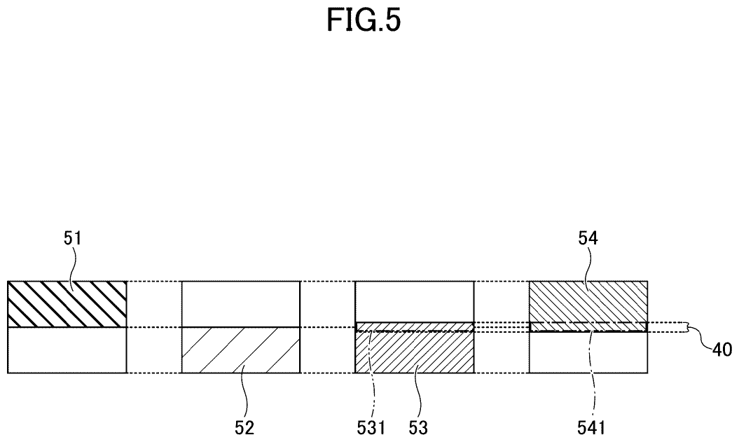

When the TEM/STEM-EDX analysis is performed on the above sample, a distribution region in which an element contained in the dielectric material contained in the dielectric layers 11 is distributed can be confirmed as shown in the leftmost view of FIG. 5. Taking, as an example, a case where the dielectric layers 11 contain barium titanate as a dielectric material, the leftmost view of FIG. 5 shows a titanium distribution region 51.

When the TEM/STEM-EDX analysis is performed on the above sample, the distribution region of the base metal element contained in the internal electrode layers 12 as a main component can be confirmed as shown in the second leftmost view of FIG. 5. Taking, as an example, where the internal electrode layers 12 contain nickel as a base metal, the second leftmost view of FIG. 5 illustrates a nickel distribution region 52.

In a case where the intermediate regions 40 have been formed, as shown in the second rightmost view of FIG. 5, in the element mapping result in which copper is mapped, a copper distribution region 53 exists beyond the nickel distribution region 52, which is the distribution region of the base metal element contained in the internal electrode layers 12 as a main component. In this case, it is observed that the copper distribution region 53 has expanded to the titanium distribution region 51, which is the distribution region of the element contained in the dielectric material contained in the dielectric layers 11.

Furthermore, as shown in the rightmost view of FIG. 5, in the element mapping result of manganese, a manganese distribution region 54 exists beyond the titanium distribution region 51, which is the distribution region of the element contained in the dielectric material contained in the dielectric layers 11. In this case, it is observed that the manganese distribution region 54 has expanded to the nickel distribution region 52, which is the distribution region of the base metal element contained in the internal electrode layers 12 as a main component.

That is, when the element mapping of copper and manganese is performed, the intermediate regions 40 can be determined as being formed, in a case where the copper distribution region 53 and the manganese distribution region 54 overlap each other at approximate boundaries where the dielectric layers 11 and the internal electrode layers 12 are laminated.

Regarding copper, there is a case where unevenness is observed in the element distribution in the copper distribution region 53. For example, as shown in the second rightmost view of FIG. 5, there may be a case where, in a part, within the copper distribution region 53, that is considered to correspond to an intermediate region 40, a thickened part 531, in which the concentration of copper is higher than that in the nickel distribution region 52, is confirmed by observation. As in this case, there may be a case where, in the region shown in the second rightmost view of FIG. 5 corresponding to an intermediate region 40, the concentration of copper is higher than that in the nickel distribution region 52 that is considered to correspond to an internal electrode layer 12.

Regarding manganese as well, there is a case where unevenness is observed in the element distribution in the manganese distribution region 54. For example, as shown in the rightmost view of FIG. 5, in a part, within the manganese distribution region 54, that is considered to correspond to an intermediate region 40, a thickened part 541, in which the concentration of manganese is higher than that in the titanium distribution region 51, is confirmed by observation. Thus, in the region shown in the rightmost view of FIG. 5 as corresponding to an intermediate region 40, the concentration of manganese is higher than that in the titanium distribution region 51 that is considered to correspond to a dielectric layer 11.

When no copper is added to the internal electrode layers 12 as has been so far, the manganese distribution region 54 includes no thickened part 541 in which the manganese concentration is higher than that in the remaining part. First of all, manganese should be present in combination with copper, in order for regions, which can be defined as the intermediate regions 40, to be formed.

The intermediate regions 40 need only to contain manganese and copper, and the states of manganese and copper in the intermediate regions 40 are not particularly limited. In the intermediate regions 40, manganese and copper may form a compound, and manganese and copper may form compounds with other elements or the like, respectively. In the intermediate regions 40, at least one of manganese or copper may exist as an element without forming a compound.

With manganese contained in the dielectric layers 11, the sintering temperature of the dielectric layers 11 can be lowered, which makes it possible to increase the continuation percentage of the internal electrode layers 12. Increasing the continuation percentage of the internal electrode layers 12 leads to an increase in the crossover area of the internal electrodes, and in the increase in the effective capacitance of the multilayer ceramic capacitor 100. This effect is particularly enhanced through increasing the manganese content in the dielectric layers 11.

However, according to the study of the inventor of the present invention, excessively increasing the manganese content in the dielectric layers 11 might deteriorate the DC bias characteristic (hereinafter simply referred to as “bias characteristic”) of the capacitance of the multilayer ceramic capacitor 100.

In this regard, by adding copper to the internal electrode layers 12 and forming the intermediate regions 40 containing copper between the internal electrode layers 12 and the dielectric layers 11, it is possible to inhibit the base metal that is the main component of the internal electrode layers 12 from diffusing toward the dielectric layers 11. Therefore, it is possible to enhance the continuation percentage of the internal electrode layers 12 in particular, and to also reduce the deterioration of the bias characteristic.

Furthermore, by adjusting the content ratio between manganese and copper contained in the intermediate regions 40 within a predetermined range, it is possible to enhance the continuation percentage of the internal electrode layers 12 in particular, and to enhance the bias characteristic as well.

### (Composition of Intermediate Regions)

The intermediate regions 40 need only to contain manganese and copper, and are not particularly limited compositionally. In order to enhance the continuation percentage of the internal electrode layers 12 and the bias characteristic in particular, it is preferable that elements are found to be distributed as shown in FIG. 5 when an STEM-EDX analysis is performed. That is, it is preferable that the average value of the ratio of manganese by number of contained atoms in an intermediate region 40 is greater than that in the center part of a dielectric layer 11 in the thickness direction. Moreover, it is preferable that the average value of the ratio of copper by number of contained atoms in an intermediate region 40 is greater than that in the center part of an internal electrode layer 12 in the thickness direction.

When a STEM-EDX analysis is performed, for example, a part, within the region in which titanium and the like as elements contained in the dielectric material contained in a dielectric layer 11 are distributed, that is other than an intermediate region 40 can be determined as the region of the dielectric layer 11. Moreover, a part, within the distribution region of nickel and the like, which is the distribution region of the base metal element contained as a main component in an internal electrode layer 12, that is other than an intermediate region 40 can be determined as the region of the internal electrode layer 12.

An intermediate region 40 can be defined as a region where, for example, the copper distribution region 53 and the manganese distribution region 54 overlap each other.

The center part of a dielectric layer 11 in the thickness direction means a position that is ½ the thickness of the dielectric layer 11, when measured from an end of the dielectric layer 11 in the thickness direction of the dielectric layer 11. The center part of an internal electrode layer 12 in the thickness direction means a position that is ½ the thickness of the internal electrode layer 12, when measured from an end of the internal electrode layer 12 in the thickness direction of the internal electrode layer 12.

The average value of the ratio of each element in each region by number of contained atoms means the average value of the concentration of each element determined by EDX, and the unit is at %. It is preferable to evaluate the above matters by a three-dimensional atom probe analysis that can calculate content ratios of elements by number of atoms at measurement positions more accurately.

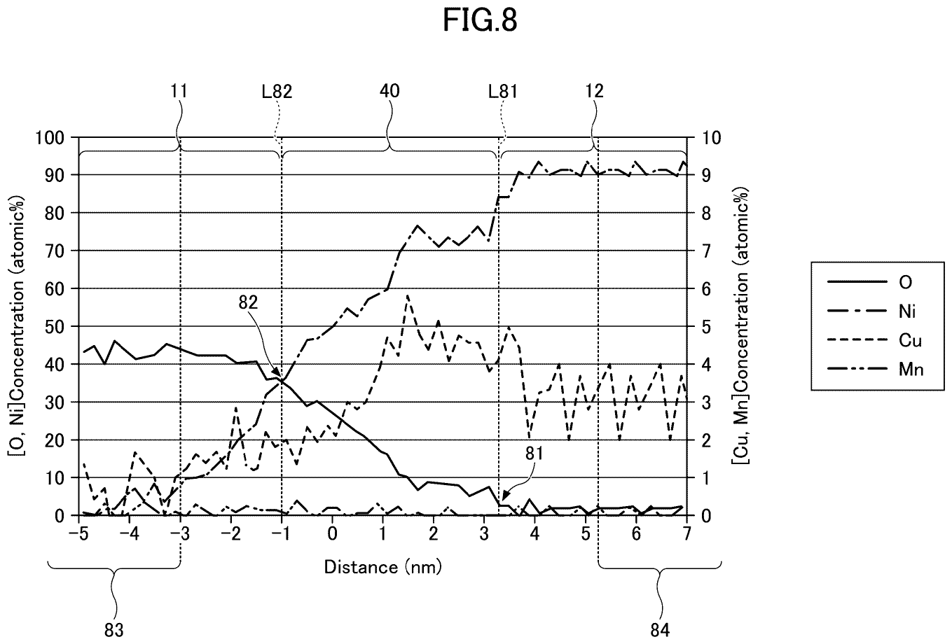

FIG. 8 shows an example of a three-dimensional atom probe analysis performed along the Z-axis, which is the first axis, from a dielectric layer 11 to an internal electrode layer 12.

In the graphs of the content ratios of elements by number of atoms at the measurement positions obtained by the three-dimensional atom probe analysis shown in FIG. 8, a first boundary L81, which is the boundary between an internal electrode layer 12 and an intermediate region 40, is defined as a straight line passing through a position at which the oxygen content ratio by number of atoms is 5 at %, i.e., a point 81. This is because the internal electrode layer 12 contains almost no oxygen.

A second boundary L82, which is the boundary between a dielectric layer 11 and an intermediate region 40, is defined as a straight line passing through a position at which the oxygen content ratio by number of atoms and the content ratio by number of atoms of the base metal element as the main component are equal, i.e., a point 82. In FIG. 8, the point 82 is the intersection at which the graph representing the content ratio by number of atoms of oxygen derived from the compound having a perovskite structure contained in the dielectric layers 11 and the graph representing the content ratio by number of atoms of the element derived from the base metal contained in the internal electrode layers 12 as the main component, which is nickel in the case of FIG. 8, intersect each other.

In this case, it is preferable that the average value of the manganese content ratio by number of atoms in an intermediate region 40 is greater than the average value of the manganese content ratio by number of atoms in a first reference region 83, which is a region, within a dielectric layer 11, that is apart from the second boundary L82 by 2 nm or greater and 5 nm or less. In particular, it is preferable that the average value of the manganese content ratio by number of atoms in the intermediate region 40 is equal to or greater than 1.5 times the average value of the manganese content ratio by number of atoms in the first reference region 83.

Moreover, it is preferable that when the three-dimensional atom probe analysis is performed, the average value of the copper content ratio by number of atoms in an intermediate region 40 is found to be greater than the average value of the copper content ratio by number of atoms in a second reference region 84, which is a region, within an internal electrode layer 12, that is apart from the first boundary L81 by 2 nm or greater and 5 nm or less.

It is preferable that the average value (Mn) of the manganese content ratio by number of atoms in the intermediate regions 40 is in a predetermined relationship with the average value (Cu) of the copper content ratio by number of atoms in the intermediate regions 40, from the viewpoint of enhancing the bias characteristics of the multilayer ceramic capacitor 100 in particular.

Specifically, for example, it is particularly preferable that the following expressions (1) and (2) are satisfied.

$$Mn \leq 0.1 \; 574 Cu + 0 \text{.1010} \qquad ( 1 )$$

$$Mn \geq 0 \text{.12} Cu - 0.08 \qquad ( 2 )$$

The effect of manganese and copper contained in the intermediate regions 40 will be described below.

### Effect of Manganese:

In the production of the multilayer ceramic capacitor 100, the firing temperature during firing can be lowered by the effect of manganese, and the continuousness of the internal electrode layers 12 can be improved as a result. Furthermore, at the end of sintering, any excessive manganese is let out (diffused) from the dielectric layers 11 to the intermediate regions 40, and deterioration of bias characteristics can be prevented as a result.

### Effect of Copper:

Copper can prevent diffusion of the base metal, which is the main component of the internal electrode layers 12, toward the dielectric layers 11. Therefore, copper contained in the intermediate regions 40 can increase the continuousness of the internal electrode layers 12 in particular, and can inhibit deterioration of the bias characteristics.

Regarding manganese and copper, it is preferable that when the three-dimensional atom probe analysis is performed for this combination, the average value of the manganese content ratio by number of atoms in the intermediate regions 40 is found to be 0.15 at % or greater and 0.40 at % or less, and the average value of the copper content ratio by number of atoms in the intermediate regions 40 is found to be 0.32 at % or greater and 3.15 at % or less.

When the three-dimensional atom probe analysis is performed, the average value of the manganese content ratio by number of atoms in an intermediate region 40 may be found to be equal to or greater than 1.5 times the average value of the manganese content ratio by number of atoms in the first reference region 83 that is the region, within the dielectric layer 11, that is apart from the second boundary L82 by 2 nm or greater and 5 nm or less, and the average value of the copper content ratio by number of atoms in an intermediate region 40 may be, for example, equal to or greater than 0.5 times and equal to or less than 3.0 times the copper content ratio by number of atoms in the center part of an adjacent internal electrode layer 12 in the thickness direction along the Z-axis, which is the first axis.

When the concentrations are analyzed and quantitatively determined by an Energy Dispersive X-ray (EDX) analysis using a Transmission Electron Microscope (TEL)/Scanning Transmission Electron Microscope (STEM), the content ratio by number of atoms of an element contained in a sample and belonging to any part other than the intermediate regions 40 might be counted in in the content ratio by number of atoms of an element contained in the intermediate regions 40, and the analysis accuracy might be low. This is because there is a possibility that preparation of a sample for TEM/STEM observation, including obtaining a thin piece shape of the sample, may cause inclusion of any part other than the intermediate regions 40 onto the back surface or the like of the sample, and the like, to make it impossible to accurately evaluate the intermediate regions 40. For example, use of a TEM/STEM-EDX analysis is not a problem in a case of comparing two regions apparently having a major difference and in like cases. However, in order to accurately analyze the content ratio of an element contained in the intermediate regions 40, the concentration determined by a three-dimensional atom probe (3DAP) analysis is used.

The average values of the content ratios of copper and manganese by number of atoms in the intermediate regions 40 can be evaluated by a procedure described in the Examples. Therefore, description thereof is omitted here.

### [Method of Producing Multilayer Ceramic Capacitor]

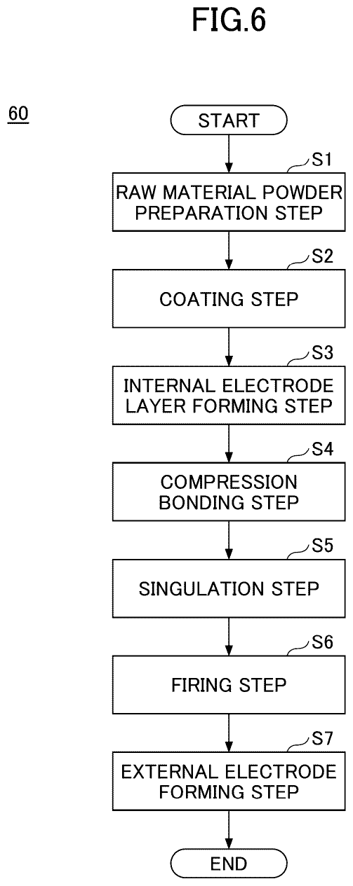

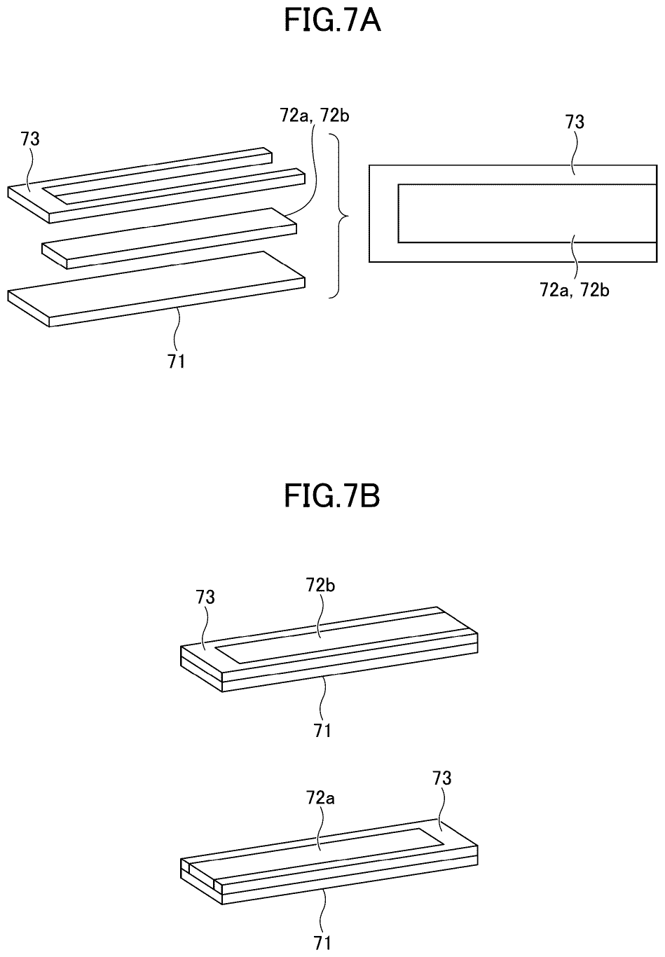

Next, a method of producing the multilayer ceramic capacitor 100 will be described. FIG. 6 is a flowchart 60 illustrating the method of producing the multilayer ceramic capacitor 100. FIGS. 7A and 7B are views illustrating the method of producing the multilayer ceramic capacitor 100.

### (1) Raw Material Powder Preparation Step (S1)

In the raw material powder preparation process, first, a dielectric material for forming the dielectric layers 11 is prepared. The A-site element and the B-site element contained in the dielectric layers 11 are typically contained in the dielectric layers 11 in the form of a sintered body of ABO_{3-α} (0≤Q≤1) particles. For example, barium titanate is a tetragonal crystal compound having a perovskite structure and exhibits a high relative permittivity. In general, barium titanate can be obtained by reacting a titanium raw material such as titanium dioxide or the like with a barium raw material such as barium carbonate or the like. Various methods have been known as the method for synthesizing the main component ceramic of the dielectric layers 11, and examples include solid-phase methods, sol-gel methods, hydrothermal methods, and the like. In this embodiment, any of these methods can be employed.

In the raw material powder preparation step, a manganese simple substance or a compound containing manganese can be added as an additive to the obtained ceramic raw material powder. In addition, a predetermined additive compound can further be added to the obtained ceramic raw material powder according to the purpose. Examples of the additive compound include: oxides containing one or more elements selected from zirconium (Zr), magnesium (Mg), molybdenum (Mo), vanadium (V), chromium (Cr) and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); oxides containing one or more elements selected from cobalt (Co), nickel (Ni), lithium (Li), boron (B), sodium (Na), potassium (K) and silicon (Si): glass containing one or more elements selected from cobalt, nickel, lithium, boron, sodium, potassium, and silicon; and the like.

For example, a ceramic material can be prepared by mixing the manganese-containing additive and a compound containing the additive compound with the ceramic raw material powder in a wet manner, and drying and grinding the resulting product. For example, as needed, the ceramic material obtained in this way may be subjected to grinding treatment to adjust the particle diameter, or may be subjected to classification treatment in combination thereto to adjust the particle diameter. The dielectric material can be obtained by the above step.

### (2) Coating Step (S2)

Next, in the coating step, a binder such as polyvinyl butyral (PVB) resin or the like, an organic solvent such as ethanol, toluene, or the like, and a plasticizer can be added to the obtained raw material powder and mixed in a wet manner. The binder and the like may be added and mixed in a wet manner when mixing the ceramic raw material powder and the like in the raw material powder preparation step (S1).

In the coating step, using the obtained slurry, a ceramic green sheet 71 can be applied to a substrate by, for example, a die coater method or a doctor blade method, and dried. An example of the substrate is a polyethylene terephthalate (PET) film. A drawing illustrating the coating step is omitted here. The ceramic green sheet 71 is an example of a dielectric green sheet.

### (3) Internal Electrode Layer Forming Step (S3)

As described above, the main component of the first internal electrode layers 12a and the second internal electrode layers 12b can be a base metal such as nickel (Ni), tin (Sn), tungsten (W), or the like, or an alloy containing any of these metals. The internal electrode layers 12 contain copper in addition to the main component described above.

The main component of the first internal electrode layers 12a and the main component of the second internal electrode layers 12b may be the same or different. As an example, the main component of the first internal electrode layers 12a and that of the second internal electrode layers 12b may both be nickel.

A metal conductive paste for forming a precursor of the first internal electrode layers 12a and the second internal electrode layers 12b can be prepared by kneading the main component selected as described above, copper, an organic binder, and a solvent. Copper may be added in a state of a simple substance or in a state of a compound. Copper may be added as an alloy containing the base metal element as the main component and copper, or copper may be added in a state in which the surface of the base metal element as the main component or a compound containing the base metal element is coated with copper or a copper compound.

In the internal electrode layer forming step, as illustrated in FIG. 7A, the metal conductive paste for internal electrode layer formation containing the organic binder can be printed on the surface of the ceramic green sheet 71 by screen printing, gravure printing, or the like. As the organic binder, for example, ethyl cellulose (EC), polyvinyl butyral (PVB) resins, and the like can be used. Thus, a first internal electrode layer pattern 72a for a first internal electrode layer 12a or a second internal electrode layer pattern 72b for a second internal electrode layer 12b are positioned on the surface of the ceramic green sheet 71. Various auxiliary agents such as a dispersant and the like, and ceramic particles as a co-existent material can be added to the metal conductive paste. The main component of the ceramic particles is not particularly limited, yet is preferably the same as that of the main component ceramic of the dielectric layers 11. When adding ceramic particles as a co-existent component, they can be added during kneading of the metal conductive paste. The method of forming the internal electrode layers is not limited to printing, and plating, vacuum vapor deposition, sputtering, or CVD may be used.

In addition, a dielectric pattern paste for a reverse pattern layer can be obtained by adding a binder such as an ethyl cellulose-based binder or the like, and an organic solvent such as a terpineol-based organic solvent or the like to the dielectric pattern material obtained in the raw material powder preparation step, and kneading them using a roll mill. Then, as illustrated in FIG. 7A, the dielectric pattern paste may be printed on a peripheral region of the ceramic green sheet 71 on which no internal electrode layer pattern is printed, to position a dielectric pattern 73 and fill the gap from the internal electrode layer pattern. The ceramic green sheet 71 on which the internal electrode layer pattern and the dielectric pattern 73 are printed is referred to as a lamination unit.

Then, as illustrated in FIG. 7B, lamination units can be laminated such that the internal electrode layers and the dielectric layers are alternate, and such that the edges of the internal electrode layers are exposed to the end surfaces of the dielectric layers on alternate sides in the length direction and drawn out to alternate ones of a pair of external electrodes (laminating step). Specifically, a ceramic green sheet 71 on which the first internal electrode layer pattern 72a and the dielectric pattern 73 are printed and a ceramic green sheet 71 on which the second internal electrode layer pattern 72b and the dielectric pattern 73 are printed are laminated in this order. For example, the number of lamination units to be laminated can be 100 to 500 layers.

### (4) Compression Bonding Step (S4)

In the compression bonding step, the laminate in which the lamination units are laminated can be thermocompression-bonded, with a predetermined number of, for example, two to ten layers, of cover sheets laminated on top and bottom of the laminate.

### (5) Singulation Step (S5)

In the singulation step, the compression-bonded body obtained by the compression bonding can be singulated into individual pieces, to obtain singulated laminates. Existing methods such as dicing with a dicer, laser cutting, and the like can be used appropriately for the singulation method.

### (6) Firing Step (S6)

In the calcination step, the singulated laminates can be degreased and fired. In the firing step, degreasing and firing may be performed continuously or separately. Conditions for degreasing and firing are not particularly limited. For example, degreasing may be performed in a nitrogen atmosphere at 250° C. or higher and 500° C. or lower.

For example, firing can be performed in a reducing atmosphere at an oxygen partial pressure of 10-12 atm or higher and 10-8 atm a or lower in a temperature range of 1,100° C. or higher and 1, 350° C. or lower for 5 minutes or longer and 10 hours or shorter. The oxygen partial pressure may preferably be 10-12 atm or higher and 10-10 atm or lower. The temperature range may preferably be 1, 150° C. or higher and 1, 350° C. or lower. The firing time may preferably be 5 minutes or longer and shorter than 15 minutes. If necessary, a re-oxidation treatment may further be performed in a nitrogen atmosphere at 600° C. or higher and 1,000° C. or lower after firing.

### (7) External Electrode Forming Step (S7)

In the external electrode forming step, an external electrode can be formed by forming a metal conductive paste for external electrode layer formation containing metals, such as a base metal contained as a main component, such as nickel or the like, and copper or the like, and an organic binder by screen printing, dipping, or the like, and baking the paste. The method for forming the external electrode is not limited to printing or dipping, and plating, vacuum vapor deposition, sputtering, or CVD may also be used. Alternatively, an external electrode may be formed by forming a conductive resin paste by screen printing, dipping, or the like, and curing the resin. As needed, a layer of copper, nickel, or tin may be formed by plating or the like. In this way, the first external electrode 20a and the second external electrode 20b can be formed. The multilayer ceramic capacitor 100 is completed through the above steps.

The above steps are examples, and the method of producing the multilayer ceramic capacitor of this embodiment is not limited to the above mode. For example, an underlayer of the external electrodes can be provided on the surface of a singulated laminate, and baked at the same time as firing the ceramic. In this way, the underlayer of the external electrodes can be formed. In this case, in the external electrode forming step after firing, the external electrodes can be completed by forming a layer of copper, nickel, or tin on the underlayer by plating.

### Other Embodiments

Although the above-described embodiment has been described in detail, the present disclosure is not limited to the specific embodiment, and various modifications and changes are applicable within the scope of description in the claims.

For example, although the above-described embodiment is applied to a multilayer ceramic capacitor having two terminal electrodes, it may also be applied to a multilayer ceramic capacitor having three or more terminals.

### EXAMPLES

Specific Examples will be described below. However, the present disclosure should not be construed as being limited to these Examples.

### (1) Evaluation Method

### (1-1) Presence or Absence of Intermediate Regions

The presence or absence of the intermediate regions 40 was confirmed by elemental mapping by an Energy Dispersive X-ray (EDX) analysis using a Scanning Transmission Electron Microscope (STEM). Since the first axis, which was in the lamination direction, was in the Z-axis direction in FIGS. 1 and 2, in the evaluation, the multilayer ceramic capacitor 100 was polished along the Y-axis, which was the third axis, to prepare a sample that exposed an XZ surface in which the dielectric layers 11 and the internal electrode layers 12 were laminated, as shown in FIGS. 1 and 2. Then, the presence or absence of the intermediate regions 40 was confirmed by performing a STEM/EDX analysis of a thin piece sample obtained from this sample to have a thickness of approximately 0.1 μm.

Specifically, a part, in an obtained elemental mapping result, in which a dielectric layer 11 and an internal electrode layer 12 were laminated, was observed.

In a case where an intermediate region 40 had been formed, in the elemental mapping result of copper, the copper distribution region 53 would exist beyond the nickel distribution region 52, which was the distribution region of the base metal element contained as the main component in the internal electrode layer 12, as shown in the second rightmost view of FIG. 5. In this case, it would be observed that the copper distribution region 53 had expanded to the titanium distribution region 51, which was the distribution region of the element contained in the dielectric material contained in the dielectric layer 11.

Furthermore, in the elemental mapping result of manganese, the manganese distribution region 54 would exist beyond the titanium distribution region 51, which was the distribution region of the element contained in the dielectric material contained in the dielectric layer 11, as shown in the rightmost view of FIG. 5. In this case, it would be observed that the manganese distribution region 54 had expanded to the nickel distribution region 52, which was the distribution region of the base metal element contained as the main component in the internal electrode layer 12.

That is, in a case where elemental mapping of copper and manganese found that a region in which the copper distribution region 53 and the manganese distribution region 54 overlapped each other had been formed at an approximate boundary where the dielectric layer 11 and the internal electrode layer 12 were laminated, it would be determined that an intermediate region 40 had been formed.

On the other hand, in a case where at least one of the copper distribution region 53 or the manganese distribution region 54 could not be confirmed, or in a case where no region in which the copper distribution region 53 and the manganese distribution region 54 overlapped each other had been formed, it would be determined that no intermediate region had been formed.

In the evaluation, the multilayer ceramic capacitor 100 was polished, to expose an XZ surface, from which six internal electrode layers 12 located in the center on the Z-axis, which is the first axis, and five internal electrode layers 12 located at each of the upper end and the lower end on the Z-axis, which is the first axis, were selected. Then, the above-described observation of the approximate interface between each selected internal electrode layer 12 and a dielectric layer 11 was performed all along the circumference of the internal electrode layer 12. The internal electrode layers 12 to be selected were selected from within the capacitive part 14.

In the “Interm. region” field of Table 1, “Present” is indicated in a case where an intermediate region 40 could be confirmed at any of the evaluated locations, and “Absent” is indicated in a case where no intermediate region could be confirmed at any of the evaluated locations.

### (1-2) Manganese and Copper Content Ratios by Number of Atoms in Intermediate Region

To compositionally analyze an intermediate region 40, the compositional analysis was performed along the Z-axis, which is the first axis, from a dielectric layer 11 to an internal electrode layer 12, using a three-dimensional atom probe (LEAP 5000XS obtained from AMETEK, Inc.). The three-dimensional atom probe is a method for measuring a three-dimensional atom distribution by applying a high voltage to a sample to detect ions that would be field-evaporated from the surface of the sample using a mass spectrometer, continuously detecting each detected ion in the depth direction, and lining up the ions in the order of the detection.

For the measurement, the multilayer ceramic capacitor 100 was polished along the Y-axis, to prepare a sample that exposed an XZ surface in which the dielectric layers 11 and the internal electrode layers 12 were laminated, as shown in FIGS. 1 and 2. The evaluation was performed in the exposed XZ surface.

An example of the measurement results is shown in FIG. 8. By performing the three-dimensional atom probe analysis, it is possible to measure and calculate the content ratio by number of atoms of each element contained in the dielectric layers 11 and the internal electrode layers 12 as shown in FIG. 8.

In the measurement results, a first boundary L81, which was the boundary between an internal electrode layer 12 and an intermediate region 40, was defined as a straight line passing through a position at which the oxygen content ratio by number of atoms was 5 at %, i.e., a point 81.

A second boundary L82, which was the boundary between a dielectric layer 11 and the intermediate region 40, was defined as a straight line passing through a position at which the oxygen content ratio by number of atoms and the content ratio by number of atoms of the base metal element as the main component are equal to each other, i.e., a point 82. The region sandwiched between the first boundary L81 passing through the point 81 and the second boundary L82 passing through the point 82 was defined as the intermediate region 40, and the contents represented by the graphs in the range from the first boundary L81 to the second boundary L82 were defined as the data of the intermediate region 40.

In Comparative Examples 1 to 6, although no intermediate region containing both manganese and copper had been formed, the evaluation was performed based on the same intermediate region definition.

Then, the average values of the manganese and copper content ratios by number of atoms in the intermediate region 40 were determined. In the evaluation, from the XZ surface exposed by polishing the multilayer ceramic capacitor 100, six dielectric layers located in the center on the Z-axis, which is the first axis, and five dielectric layers located at each of the upper end and the lower end on the Z-axis, which is the first axis, were selected. Then, the three-dimensional atom probe analysis was performed from each selected dielectric layer 11 to the internal electrode layer 12 located thereabove on the first axis, and the average values of the manganese and copper content ratios with respect to all detected elements in the intermediate region 40 were determined. The dielectric layers 11 to be selected were selected from within the capacitive part 14.

The average values of the manganese and copper content ratios in all of the evaluated intermediate regions 40 are shown in the “Mn” and “Cu” fields under the “Avg. value of elem. content ratio by number of atoms in interm. regions (at %)” field of Table 1, respectively.

The average value of the manganese content ratio by number of atoms in a first reference region 83, which is a region, within the dielectric layer 11, that is apart from the second boundary L82 by 2 nm or greater and 5 nm or less, was calculated, and shown in the “Avg. value of Mn content ratio by number of atoms in first reference regions (at %)” field of Table 1.

### (1-3) Internal Electrode Layer Continuation Percentage, and Internal Electrode Layer Continuation Percentage Judgment

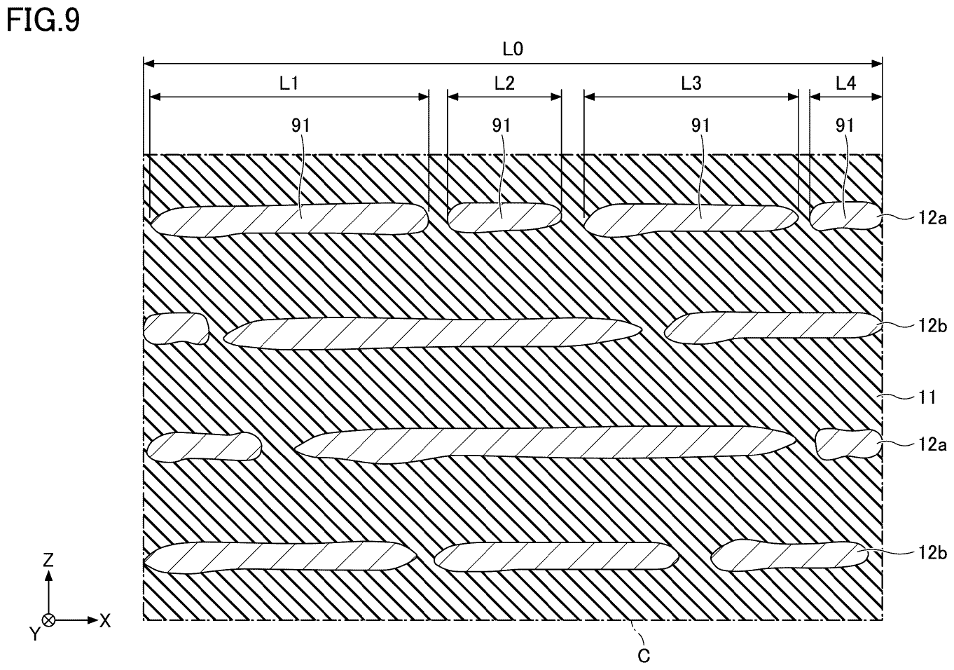

The continuation percentage of the internal electrode layers 12 can be calculated as follows. In the evaluation, the multilayer ceramic capacitor 100 was polished along the Y-axis, to prepare a sample that exposed an XZ surface in which the dielectric layers 11 and the internal electrode layers 12 were laminated, as shown in FIGS. 1 and 2. Next, regarding the exposed XZ surface as an observation surface, a region C (see FIG. 2) included in the observation surface was observed by a Scanning Electron Microscope (SEM). Here, as shown in FIG. 9, each region that appeared bright due to a contrast difference in the SEM image was identified as an electrode part 91. Then, the length of the electrode part 91 (in the example shown, the length along the X-axis direction) was measured, and the measured length values L1, L2, . . . , and Ln were summed. A value obtained by dividing the total length of the electrode parts 91 in the region C by the length L0 of the length measurement region (i.e., (L1+L2+ . . . +Ln)/L0) can be defined as the continuation percentage of one first internal electrode layer 12a. The element body 10 includes the plurality of first internal electrode layers 12a, and the continuation percentage can vary depending on which layer of the plurality of first internal electrode layers 12a to put a focus on. Therefore, a plurality of different internal electrode layers 12 were selected, and the average of the continuation percentages calculated for the respective selected internal electrode layers 12 was defined as the continuation percentage of the internal electrode layers 12 of the multilayer ceramic capacitor 100. The condition based on which to select among a plurality of different internal electrode layers 12 used for the evaluation can be the same as the condition when determining the thickness of the internal electrode layers 12.

Therefore, in the evaluation, six internal electrode layers 12 located in the center on the Z-axis, which was the first axis, and five internal electrode layers 12 located at each of the upper end and the lower end on the Z-axis, which was the first axis, were selected from the XZ surface exposed by polishing the multilayer ceramic capacitor 100. The internal electrode layers 12 to be selected were selected from within the capacitive part 14.

In the measurement of the internal electrode layer continuation percentage, ten multilayer ceramic capacitors produced under the same conditions were evaluated in each Experimental Example. The average value of the internal electrode layer continuation percentages of the ten multilayer ceramic capacitors was used as the internal electrode layer continuation percentage of the multilayer ceramic capacitor of Experimental Example concerned.

In the internal electrode layer continuation percentage judgment, the calculated internal electrode layer continuation percentage was evaluated as “A” when it was 75% or greater, and as “C” when it was less than 75%. The evaluation results are shown in the “Int. EDL layer contin. pct. JDG” field of Table 1.

### (1-4) DC Bias Characteristic, and DC Bias Characteristic Judgment

A capacitance change rate was measured and calculated according to the following equation (1) based on a capacitance CO measured under no load and a capacitance C3V measured under DC 3 V application.

$$Capacitance change rate = ( C 3 V - C 0 ) / C 0 \times 100 \qquad ( 1 )$$

To measure the DC bias characteristic, ten multilayer ceramic capacitors produced under the same conditions were evaluated in each Experimental Example. The average value of the DC bias characteristics of the ten multilayer ceramic capacitors was used as the DC bias characteristic of the multilayer ceramic capacitor of the Experimental Example concerned.

In the “DC bias char.” field of Table 1, values normalized by regarding the capacitance change rate in Comparative Example 2 as 100 are shown.

In the DC bias characteristic judgment, the measured DC bias characteristic was evaluated as “A” when it was 100 or greater, as “B” when it was 85 or greater and less than 100, and as “C” when it was less than 85.

(1-5) Comprehensive Judgment The comprehensive judgment was “A” when the internal electrode layer continuation percentage judgment was “A” and the DC bias characteristic judgment was “A”, and was “B” when the internal electrode layer continuation percentage judgment was “A” and the DC bias characteristic judgment was “B”. The comprehensive judgment was “C” when at least one of the internal electrode layer continuation percentage judgment or the DC bias characteristic judgment was “C”.

### (2) Sample Preparation Conditions

### Example 1

A multilayer ceramic capacitor was produced according to the flowchart 60 shown in FIG. 6.

Specifically, first, a barium titanate powder, a polyvinyl butyral (PVB) resin, a solvent, a plasticizer, a glass powder containing SiO₂ as a sintering aid, and manganese carbonate (MnCO₃) were mixed in a wet manner, to obtain a slurry (raw material powder preparation step).

The obtained slurry was applied to a substrate film, and the slurry applied to the substrate film was dried to obtain a ceramic green sheet (coating step).

Next, an organometallic complex solution containing copper was added to an Ni powder as the main component metal element, and mixed, to prepare a mixed powder. Ethyl cellulose (EC), a polyvinyl butyral (PVB) resin, or the like serving as a binder, a solvent, and a plasticizer were added to the prepared mixed powder, and they were mixed in a wet manner, to obtain an internal electrode paste. There would be no problem in adding required amounts of various auxiliary agents, such as a dispersant and the like, as needed. Then, the internal electrode paste was printed on a part of the surface of the ceramic green sheet, to form an internal electrode layer pattern on each ceramic green sheet, to form lamination units (internal electrode layer forming step). Each of these lamination units includes the ceramic green sheet and the internal electrode layer pattern formed on the surface of the ceramic green sheet.

Next, five hundred lamination units were laminated to form a laminate, and the laminate was compression-bonded and then singulated, to obtain chip-shaped green laminates (compression-bonding step and singulation step).

Next, the chip-shaped green laminates were degreased in a nitrogen atmosphere at 500° C.

A metal conductive paste containing a metal filler containing nickel as a main component, a co-existent material, a binder, a solvent, and the like was applied to the green laminates after being degreased, from both end surfaces to respective side surfaces of the green laminates, and dried. The green laminates to which the external electrode underlayer was applied were set in a firing furnace and fired. During firing, the firing temperature was 1, 300° C., and the firing time, which was the retention time at the firing temperature, was 10 minutes (firing step).

The first external electrode 20a and the second external electrode 20b were formed on the fired laminates by plating (external electrode forming step).

Each obtained multilayer ceramic capacitor had a chip shape of 1.0 mm×0.5 mm×0.5 mm, a dielectric layer 11 thickness of 0.8 μm, an internal electrode layer 12 thickness of 0.6 μm, and a number of laminated layers of 500. The thickness of the dielectric layers 11 and the internal electrode layers 12 were evaluated by the procedure described above.

The obtained multilayer ceramic capacitors were subjected to the evaluations described above. The evaluation results are shown in Table 1.

In Example 1 and Examples 2 to 14 described below, the average value of the copper content ratio by number of atoms in the intermediate regions 40 was greater than the average value of the copper content ratio by number of atoms in the second reference region, which was the region, within the internal electrode layers 12, that was apart from the first boundary L81 by 2 nm or greater and 5 nm or less.

### Examples 2 to 14

Multilayer ceramic capacitors were produced by the same procedure as in Example 1 except that the amounts of manganese and copper added to the raw materials of the dielectric layers 11 and the internal electrode layers 12 were changed such that the average values of the manganese and copper content ratios by number of atoms in the intermediate regions would be the values shown in Table 1. The obtained multilayer ceramic capacitors were subjected to the evaluations described above. The evaluation results are shown in Table 1.

### Comparative Example 1

A multilayer ceramic capacitor was produced by the same procedure as in Example 1, except that manganese was not added to the raw material of the dielectric layers 11, and the amount of copper added to the raw material of the internal electrode layers 12 was changed such that the average value of the copper content ratio by number of atoms in the intermediate regions 40 would be the value shown in Table 1. The obtained multilayer ceramic capacitor was subjected to the evaluations described above. The evaluation results are shown in Table 1.

### Comparative Examples 2 to 5

Multilayer ceramic capacitors were produced by the same procedure as in Example 1, except that copper was not added to the internal electrode layers 12, and the amount of manganese added to the raw material of the dielectric layers 11 was changed such that the average value of the manganese content ratio by number of atoms in the intermediate regions 40 would be the values shown in Table 1. The obtained multilayer ceramic capacitors were subjected to the evaluations described above. The evaluation results are shown in Table 1.

### Comparative Example 6

A multilayer ceramic capacitor was produced by the same procedure as in Example 1, except that the amounts of manganese and copper added to the raw materials of the dielectric layers 11 and the internal electrode layers 12 were changed such that the average values of the manganese and copper content ratios by number of atoms in the intermediate regions 40 would be the values shown in Table 1, and the firing time after degreasing was 2 hours. The obtained multilayer ceramic capacitor was subjected to the evaluations described above. The evaluation results are shown in Table 1.

TABLE 1

| | | | | | | Int. | | | |
|---|---|---|---|---|---|---|---|---|---|
| | | Avg. value of Mn | | | | EDL | | | |
| | | content ratio by | Avg. value of elem. content | | Int. EDL | layer | | DC | |
| | | number of atoms | ratio by number of atoms | | layer | contin. | DC | bias | |
| | Interm. | in first reference | in interm. regions (at %) | | contin. | pct. | bias | char. | Compr. |
| | region | regions (at %) | Mn | Cu | pct. (%) | JDG | char. | JDG | JDG |
| Ex. 1 | Present | 0.08 | 0.15 | 0.32 | 83 | A | 103 | A | A |
| Ex. 2 | Present | 0.07 | 0.15 | 0.63 | 85 | A | 109 | A | A |
| Ex. 3 | Present | 0.08 | 0.15 | 1.89 | 90 | A | 120 | A | A |
| Ex. 4 | Present | 0.09 | 0.20 | 0.63 | 89 | A | 115 | A | A |
| Ex. 5 | Present | 0.10 | 0.20 | 1.89 | 88 | A | 110 | A | A |
| Ex. 6 | Present | 0.17 | 0.30 | 1.89 | 91 | A | 119 | A | A |
| Ex. 7 | Present | 0.16 | 0.30 | 3.15 | 92 | A | 110 | A | A |
| Ex. 8 | Present | 0.22 | 0.40 | 3.15 | 94 | A | 115 | A | A |
| Ex. 9 | Present | 0.08 | 0.15 | 3.15 | 87 | A | 98 | B | B |
| Ex. 10 | Present | 0.09 | 0.20 | 0.32 | 8.3 | A | 91 | B | B |
| Ex. 11 | Present | 0.10 | 0.20 | 3.15 | 89 | A | 98 | B | B |
| Ex. 12 | Present | 0.19 | 0.40 | 0.32 | 89 | A | 90 | B | B |
| Ex. 13 | Present | 0.07 | 0.15 | 4.41 | 75 | A | 89 | B | B |
| Ex. 14 | Present | 0.29 | 0.50 | 1.89 | 93 | A | 89 | B | B |
| Comp. | Absent | — | — | 1.89 | 65 | C | 89 | B | C |
| Ex. 1 | | | | | | | | | |
| Comp. | Absent | 0.15 | 0.15 | — | 73 | C | 100 | A | C |
| Ex. 2 | | | | | | | | | |
| Comp. | Absent | 0.08 | 0.08 | — | 70 | C | 104 | A | C |
| Ex. 3 | | | | | | | | | |
| Comp. | Absent | 0.20 | 0.20 | — | 85 | A | 70 | C | C |
| Ex. 4 | | | | | | | | | |
| Comp. | Absent | 0.30 | 0.30 | — | 89 | A | 84 | C | C |
| Ex. 5 | | | | | | | | | |
| Comp. | Absent | 0.15 | 0.15 | 1.89 | 70 | C | 88 | B | C |
| Ex. 6 | | | | | | | | | |

According to the results shown in Table 1, in Examples 1 to 14 in which the intermediate regions 40 were formed, the internal electrode layer continuation percentage was 75% or greater, and it was confirmed that the continuation percentage of the internal electrode layers 12 was high.

According to Comparative Examples 2 to 5, as the effect of manganese, it can be seen that the greater the average value of the manganese content ratio by number of atoms in the intermediate regions 40, the greater the continuation percentage of the internal electrode layers 12, but the poorer the DC bias characteristics. When the intermediate regions 40 were free of manganese as in Comparative Example 1, the continuation percentage of the internal electrode layers 12 became extremely low.

When the average value of the manganese content ratio by number of atoms in the intermediate regions 40 did not differ from the average value of the manganese content ratio by number of atoms in the dielectric layers 11 as in Comparative Example 6, the continuation percentage of the internal electrode layers 12 was low. This is considered due to the manganese's effect of preventing excessive sintering of the internal electrode layers 12 being offset in a case where firing is excessive, such as the firing time being long and the like, although manganese is thickened in the intermediate regions 40 through firing.

In Examples 1 to 8, the average value of the manganese content ratio by number of atoms and the average value of the copper content ratio by number of atoms in the intermediate regions 40 were combined particularly optimally, and the continuation percentage of the internal electrode layers 12 and the DC bias characteristic were both evaluated as “A”, i.e., “excellent”.

In Examples 9, 11, and 13, although the average value of the manganese content ratio by number of atoms was low, the average value of the copper content ratio by number of atoms was rather high. It is considered that any excess copper had diffused into the dielectric layers 11, to have impacts on the bias characteristic.

In Examples 10 and 12, since the ratio of the average value of the copper content ratio by number of atoms to the average value of the manganese content ratio by number of atoms in the intermediate regions 40 was small, it is considered that the combination effect of manganese and copper became low, to have impacts on the bias characteristic.

In Example 14, it is considered that the average value of the manganese content ratio by number of atoms in the dielectric layers 11 almost reached an excessive level, to have impacts on the bias characteristic.

When the average value of the manganese content ratio by number of atoms in the intermediate regions is 0.15 at % or greater and 0.40 at % or less, the optimal average value of the copper content ratio by number of atoms is 0.32 at % or greater and 3.15 at % or less. This can be appreciated from the fact that the samples of Examples 1 to 9 were excellent both in the continuousness and the bias characteristics.

Although the detailed mechanism behind this is yet to be elucidated, the following hypothesis is conceivable.

It is considered that simultaneous presence of manganese and copper in the intermediate regions causes manganese and copper to react with each other and form an Mn—Cu—O oxide. This is considered to inhibit migration of substances between the intermediate regions and the dielectric layers, to inhibit decrease in the manganese concentration in the dielectric layers due to manganese migration from the dielectric layers to the intermediate regions, and to inhibit diffusion of copper into the dielectric layers due to copper migration from the internal electrode layers into the dielectric layers through the intermediate regions. On the other hand, when either manganese or copper is excessive in the intermediate regions, the excessive manganese or copper, which does not form the Mn—Cu—O oxide, tends to migrate into other layers, causing a decrease in the manganese concentration in the dielectric layers and diffusion of copper into the dielectric layers. Therefore, in order to improve the internal electrode continuation percentage and the bias characteristics in particular, it is considered important that manganese and copper are contained in the intermediate regions in appropriate amounts for each other.

Aspects of the present disclosure are, for example, as follows.
<1> A multilayer ceramic electronic component, including:
a plurality of dielectric layers laminated along a first axis;
a plurality of internal electrode layers each positioned between those of the dielectric layers that are adjacent to each other along the first axis; and
intermediate regions positioned between the dielectric layers and the internal electrode layers,
wherein the dielectric layers contain a compound represented by a general formula ABO_{3-α} (0≤α≤1) and having a perovskite structure, and manganese,
wherein the internal electrode layers contain a base metal element as a main component, and copper,
wherein the intermediate regions contain manganese and copper, and
wherein when a three-dimensional atom probe analysis is performed, to find first boundaries, which are boundaries between the internal electrode layers and the intermediate regions, to be at positions at which a content ratio of oxygen by number of atoms is 5 at %, and to find second boundaries, which are boundaries between the dielectric layers and the intermediate regions, to be at positions at which a content ratio of oxygen by number of atoms and a content ratio by number of atoms of the base metal element as the main component are equal to each other, an average value of a content ratio of manganese by number of atoms in the intermediate regions is greater than an average value of a content ratio of manganese by number of atoms in first reference regions, which are regions, within the dielectric layers, that are apart from the second boundaries by 2 nm or greater and 5 nm or less.
<2> The multilayer ceramic electronic component according to <1>,
wherein when the three-dimensional atom probe analysis is performed, the average value of the content ratio of manganese by number of atoms in the intermediate regions is equal to or greater than 1.5 times the average value of the content ratio of manganese by number of atoms in the first reference regions.
<3> The multilayer ceramic electronic component according to <1> or <2>,
wherein when the three-dimensional atom probe analysis is performed, an average value of a content ratio of copper by number of atoms in the intermediate regions is greater than an average value of a content ratio of copper by number of atoms in second reference regions, which are regions, within the internal electrode layers, that are apart from the first boundaries by 2 nm or greater and 5 nm or less.
<4> The multilayer ceramic electronic component according to any of <1> to <3>,
wherein when the three-dimensional atom probe analysis is performed, the average value of the content ratio of manganese by number of atoms in the intermediate regions is 0.15 at % or greater and 0.40 at % or less, and an average value of a content ratio of copper by number of atoms in the intermediate regions is 0.32 at % or greater and 3.15 at % or less.
<5> The multilayer ceramic electronic component according to any of <1> to <4>,
wherein a continuation percentage of the internal electrode layers is 75% or greater.
<6> The multilayer ceramic electronic component according to any of <1> to <5>,
wherein the internal electrode layers contain nickel.
<7> The multilayer ceramic electronic component according to any one of <1> to <6>,
wherein the dielectric layers contain barium titanate as the compound having the perovskite structure.

What is claimed is:

1. A multilayer ceramic electronic component, comprising:
a plurality of dielectric layers laminated along a first axis;
a plurality of internal electrode layers each positioned between those of the dielectric layers that are adjacent to each other along the first axis; and
intermediate regions positioned between the dielectric layers and the internal electrode layers,
wherein the dielectric layers contain a compound represented by a general formula ABO_{3-α} (0≤x≤1) and having a perovskite structure, and manganese,
wherein the internal electrode layers contain a base metal element as a main component, and copper,
wherein the intermediate regions contain manganese and copper, and
wherein when a three-dimensional atom probe analysis is performed, to find first boundaries, which are boundaries between the internal electrode layers and the intermediate regions, to be at positions at which a content ratio of oxygen by number of atoms is 5 at %, and to find second boundaries, which are boundaries between the dielectric layers and the intermediate regions, to be at positions at which a content ratio of oxygen by number of atoms and a content ratio by number of atoms of the base metal element as the main component are equal to each other, an average value of a content ratio of manganese by number of atoms in the intermediate regions is greater than an average value of a content ratio of manganese by number of atoms in first reference regions, which are regions, within the dielectric layers, that are apart from the second boundaries by 2 nm or greater and 5 nm or less.

2. The multilayer ceramic electronic component according to claim 1,
wherein when the three-dimensional atom probe analysis is performed, the average value of the content ratio of manganese by number of atoms in the intermediate regions is equal to or greater than 1.5 times the average value of the content ratio of manganese by number of atoms in the first reference regions.

3. The multilayer ceramic electronic component according to claim 1,
wherein when the three-dimensional atom probe analysis is performed, an average value of a content ratio of copper by number of atoms in the intermediate regions is greater than an average value of a content ratio of copper by number of atoms in second reference regions, which are regions, within the internal electrode layers, that are apart from the first boundaries by 2 nm or greater and 5 nm or less.

4. The multilayer ceramic electronic component according to claim 1,
wherein when the three-dimensional atom probe analysis is performed, the average value of the content ratio of manganese by number of atoms in the intermediate regions is 0.15 at % or greater and 0.40 at % or less, and an average value of a content ratio of copper by number of atoms in the intermediate regions is 0.32 at % or greater and 3.15 at % or less.

5. The multilayer ceramic electronic component according to claim 1,
wherein a continuation percentage of the internal electrode layers is 75% or greater.

6. The multilayer ceramic electronic component according to claim 1,
wherein the internal electrode layers contain nickel.

7. The multilayer ceramic electronic component according to claim 1,
wherein the dielectric layers contain barium titanate as the compound having the perovskite structure.
